(19) United States
(12) Patent Application Publication
(10) Pub. No.: US 2005/0052129 A1
(43) Pub. Date: Mar. 10, 2005

(54) Electroluminescent material

(75) Inventor: Seiji Yamashita, Minami-ashigara-shi (JP)

Correspondence Address: BURNS DOANE SWECKER & MATHIS L L P, POST OFFICE BOX 1404, ALEXANDRIA, VA, 22313-1404, US

(73) Assignee: Fuji Photo Film Co., Ltd., Minami-ashigara-shi (JP)

(21) Appl. No.: 10/935,440

(22) Filed: Sep. 8, 2004

(30) Foreign Application Priority Data
Sep. 8, 2003 (JP) 2003-315563

(51) Int. Cl. H01J 1/62; H01J 63/04

(52) U.S. Cl. 313/506

(57) ABSTRACT

An electroluminescent material, which has: a light-emitting layer that contains a luminescent particle having an average equivalent sphere diameter of from 2 nm to 150 nm, and that has a thickness of from 0.3 μm to 5 μm; and a dielectric layer of dielectric constant of 100 or more, adjacent to the light-emitting layer.

### FIELD OF THE INVENTION

The present invention relates to an AC drive-type electroluminescent device that is extremely thin and has such excellent flexibility that the device can be bent, and that is capable of emitting light uniformly over a large area. Further, the present invention relates to an electroluminescent material that can be used in the electroluminescent device.

### BACKGROUND OF THE INVENTION

In AC drive-type electroluminescent materials, particle-dispersion-type ones are relatively easily made into a large area. For this advantage, development of plane-type light emission sources using these materials has progressed. As diversification of various electronic machinery and tools has advanced in recent years, these materials have also been applied to display materials for decoration, in addition to display devices of electronic machinery and tools.

Electroluminescent devices are divided broadly into dispersion-type electroluminescent devices, in which phosphor particles are dispersed in a high-dielectric substance, and thin film-type electroluminescent devices, having a phosphor thin film sandwiched between dielectric layers.

In the dispersion-type electroluminescent device, a luminescence (light-emitting) layer, comprising a phosphor powder contained in a high-dielectricity polymer, such as a fluorine-containing rubber or a polymer having a cyano group, is arranged between a pair of electrically conductive electrode sheets, at least one of which is light-transmissible. In an ordinary form of the particle-dispersion type, a dielectric layer is arranged, to prevent dielectric breakdown. The dielectric layer comprises a powder of a ferroelectric substance, such as barium titanate, contained in a highly dielectric polymer. The phosphor powder used in this type generally comprises ZnS, as a host material thereof, which is doped with an appropriate amount of ions of Mn, Cu, Cl, Ce or the like. The particle size that the phosphor powder has, is generally 10 to 30 μm.

Since a high-temperature process is not required to produce the particle dispersion type, the dispersion-type electroluminescent device has following advantageous characteristics: A flexible device (material structure) having a plastic as a substrate can be produced; the type can be produced at low costs through relatively simple steps without using a vacuum machine; and the luminous color of the device can easily be adjusted by mixing a plurality of kinds of phosphor particles that give different luminous colors. Thus, this type is applied to back lights in LEDs and the like, and display devices. However, the light-emission luminance thereof is low. As a result, the scope to which the dispersion-type electroluminescent device can be applied is restricted, and it is therefore desired to improve the light-emission luminance and the luminous efficiency further.

The thin-film-type electroluminescent device comprises, on an electrically conductive substrate, a pair of dielectric layers, and a homogeneous light-emitting layer sandwiched between the dielectric layers. These films are sub-micron thin films formed by a vacuum process. A typical example of the material for the light-emitting layer is ZnS, which is doped with ions of Mn, Tb, or the like, as luminescence centers. To these basic layers, an insulating layer, to prevent dielectric breakdown; a diffusion barrier layer, to prevent inter-layer movement of ions; and other layers, may be occasionally added.

The thin film-type device has enabled applying a high electric field to a thin light-emitting layer of from about 500 nm to about 700 nm, to increase light-emission intensity drastically.

However, this thin film type is driven by applying a high voltage to the thin laminated layer structure thereof; therefore, dielectric breakdown may be destructively caused in a defective site of the film. Accordingly, delicate management in the production thereof, such as protection against dust, is required, which accompanies difficulty in production of a large-area device. To solve the aforementioned problem, a method of employing thick film dielectrics having a high dielectric constant is described in U.S. Pat. No. 5,432,015 and WO 00/70917. Technology of the Mn dope-type has progressed so that emission luminance of up to about 3,000 candela/m² can be obtained under high-frequency driving conditions.

In use application to a display, it is difficult to obtain light emission of blue, green, and red with high color purity necessary to attain excellent color reproduction. As a result, improvement of color purity by means of a filter is needed. However, use of a filter involves such problems as complication of the display structure and loss or deterioration of luminance.

Further, in use application to a white light source, such as a back-light, it is difficult to obtain genuine white color.

It is known that, even though plural ions having different emission (luminous) maximums from each other are doped in the conventional thin film-type electroluminescent device, large influence by energy transfer among these ions makes it difficult to adjust luminescent colors.

### SUMMARY OF THE INVENTION

The present invention resides in an electroluminescent material, which comprises:
a light-emitting layer that contains a luminescent particle having an average equivalent sphere diameter of from 2 nm to 150 nm, and that has a thickness of from 0.3 μm to 5 μm; and
a dielectric layer of dielectric constant of 100 or more, adjacent to the light-emitting layer.

Other and further features and advantages of the invention will appear more fully from the following description.

### DETAILED DESCRIPTION OF THE INVENTION

According to the present invention, there are provided the following means:

(1) An electroluminescent material, comprising:
a light-emitting layer that contains a luminescent particle having an average equivalent sphere diameter of from 2 nm to 150 nm, and that has a thickness of from 0.3 μm to 5 μm; and
a dielectric layer of dielectric constant of 100 or more, adjacent to the light-emitting layer;

(2) The electroluminescent material according to the above item (1), wherein the luminescent particle in the light-emitting layer has a coefficient of variation of 20% or less, in terms of equivalent sphere diameter; and

(3) The electroluminescent material according to the above item (1) or (2), wherein a thickness of the dielectric layer is in the range of from 0.5 μm to 30 μm, and variation of the thickness is ±10% or less.

Herein, the term “equivalent sphere diameter” means a diameter of a sphere whose volume is equal to that of an individual particle. Further, the term “average equivalent sphere diameter” means an arithmetic mean of the equivalent sphere diameters of individual particles measured.

The present invention is explained in detail below.

The luminescent particles for use in the present invention are composed of particles having an average equivalent sphere diameter of preferably from 2 nm to 150 nm, more preferably from 2 nm to 100 nm. If the average particle size is too small, when such small particles are dispersed to prepare a coating solution, such a problem arises that they are apt to cause aggregation, and the like. On the other hand, if the average particle size is too large, it is difficult to form a thin film and moreover reduction of luminous efficiency sometime occurs. A thickness of the light-emitting layer (luminous substance layer) is preferably in the range of from 0.3 μm to 5 μm, and more preferably in the range of from 0.5 μm to 5 μm. If the thickness is too thin, it is difficult to coat uniformly a light-emitting layer, and also luminous unevenness resulting from ununiformity of the thickness sometimes causes a problem. On the other hand, if the thickness is too thick, not only the resultant electroluminescent materials become thick, but also when the electroluminescent materials are bent, they are apt to crack, or electric field strength is apt to decline, resulting in reduction of emission luminance.

Materials of the dielectric layer are very important to formation of such particle dispersion-type thin electroluminescent materials as the present invention.

In particular, in the present invention, it is important that a dielectric constant of the dielectric layer is 100 or more. If the dielectric constant is too low, effective (active) electric field may not be applied to the light-emitting layer, which results in lowering of the luminance.

If a high voltage is applied to enhance the luminance, dielectric breakdown may be apt to occur, so that it becomes particularly difficult to make the electroluminescent material or device into a large area that is easily affected by fluctuation of the thickness.

A dielectric constant of the dielectric layer for use in the present invention is preferably 100 or more, particularly preferably 200 or more. It is preferable that the dielectric constant is as high as possible. Factually, however, when a high permittivity is required, a dielectric layer is baked and large size dielectric particles are used in response to such requirement. A high-temperature baking makes it difficult to use flexible materials composed of organic substances such as polyethylene terephthalate. To make the dielectric particles into a large size results in loss of uniformity and smoothness of the dielectric layer. Thereby, troubles such as dielectric breakdown under applied voltage may occur.

The base (host) material of luminescent particles (phosphor particles), which can be preferably used in the present invention, is specifically a semiconductor fine-particle that is composed of one or more selected from the group consisting of elements of the II group and elements of the VI group, or one or more selected from the group consisting of elements of the III group and elements of the V group, and these elements may be selected at will in accordance with a required luminescence wavelength region. Herein, the II, III, V and VI groups are those in the periodic table of elements. As the semiconductor, II-VI group or III-V group compound semiconductors are preferable. Examples of these compounds include CdS, CdSe, CdTe, ZnS, ZnSe, ZnTe, CaS, MgS, SrS, GaP, GaAS, and mixed crystals of these compounds. In particular, ZnS, CdS and CaS can be preferably used.

In addition to the above, as a host material of the phosphor particles, BaAl₂S₄, CaGa₂S₄, Ga₂O₃, Zn₂SiO₄, Zn₂GaO₄, ZnGa₂O₄, ZnGeO₃, ZnGeO₄, ZnAl₂O₄, CaGa₂O₄, CaGeO₃, Ca₂Ge₂O₇, CaO, Ga₂O₃, GeO₂, SrAl₂O₄, SrGa₂O₄, SrP₂O₇, MgGa₂O₄, Mg₂GeO₄, MgGeO₃, BaAl₂O₄, Ga₂Ge₂O₇, BeGa₂O₄, Y₂SiO₅, Y₂GeO₅, Y₂Ge₂O₇, Y₄GeO₈, Y₂O₃, Y₂O₂S, SnO₂, or mixed crystals thereof, can be preferable used.

As the luminescence center, ions of metal such as Mn and Cr, and rare earth elements such as Eu and Tb, can be preferably used.

The phosphor fine-particles for use in the present invention are preferably prepared according to a hydrothermal method. Taking zinc sulfide as an example, ZnS crystals have extremely low solubility to water. Such property is indeed very disadvantage to a method of growing particles upon the ionic reaction in an aqueous solution. A solubility of ZnS crystals to water increases as a temperature of water is elevated. However, water turns a supercritical state at 375° C. or more. In the supercritical state, a solubility of ions extremely reduces. Accordingly, a temperature for preparing particles is preferably a room temperature or more but not more than 375° C., more preferably in the range of 100° C. or higher but lower than 375° C. A time to be spent for preparing particles is preferably within 100 hours, more preferably within 12 hours, but 5 minutes or more.

It is also preferable to use a chelating agent in the present invention, as another method of increasing the solubility of zinc sulfide in water. As a chelating agent of Zn ion, those having an amino group and/or a carboxyl group are preferable. Specific examples of the chelating agent include ethylenediaminetetraacetic acid (hereinafter referred to as EDTA), N,2-hydroxyethylethylenediaminetriacetic acid (hereinafter referred to as EDTA-OH), diethylenetriaminepentaacetic acid, 2-aminoethylethylene-glycol-tetraacetic acid, 1,3-diamino-2-hydroxypropanetetraacetic acid, nitrilotriacetic acid, 2-hydroxyethyliminodiacetic acid, iminodiacetic acid, 2-hydroxyethylglycine, ammonia, methylamine, ethylamine, propylamine, diethylamine, diethylenetriamine, triaminotriethylamine, allylamine, and ethanolamine. The employment of such a chelating agent is not restricted to ZnS, but a common idea.

When particles are prepared by direct precipitation reaction of a constituting metal ion with a chalcogen anion, without using any precursor of the constituting elements, rapid mixing of solutions of the two is necessary. It is preferable to use a mixer of a double-jet type.

The particle size distribution of the luminescent particles for use in the present invention is preferably 20% or less. The term “particle size” herein used means an equivalent sphere diameter of the particle. The term “particle size distribution” herein used means a coefficient of variation relative to the equivalent sphere diameters of the particles.

The narrower the particle size distribution is, the better the luminous property is. The particle size distribution is more preferably 15% or less.

In the case that the particle size distribution is too broad, a film thickness of the light-emitting layer is hardly unified and a scattering in luminous properties arises among particles under the influence of the broad distribution. For this reason, the resulting materials or devices exert a very slow build up of luminescence to an applied voltage. As a result, a high voltage and a large power are needed to obtain a high luminance.

The light-emitting layer in the electroluminescent material or device of the present invention can be formed according to a usual manner, for example, by a coating method described below, using any material such as a binder, except for using the aforementioned specific phosphor particle of the present invention.

The dielectric material to be used in the dielectric layer according to the present invention, may be made of any material that has a high dielectric constant, a high insulating property, and a high dielectric breakdown voltage. This material can be selected from metal oxides and nitrides. For example, any of the followings can be used: BaTiO₃, KNbO₃, BaTiO₃, LiNbO₃, LiTaO₃, Ta₂O₃, BaTa₂O₆, Y₂O₃, Al₂O₃, and AlON. Employment of these materials in the form of a film having a particle structure rather than uniformity enables material formation to be carried out by coating. For example, use can be made of a film composed of BaTiO₃ fine particles and BaTiO₃ sol, as described in Mat. Res. Bull., Vol. 36., p. 1065.

In general, though it depends on the dielectric constant of the film, the thickness of the film is preferably made as thin as possible, as long as dielectric breakdown, or dielectric breakdown at a defective portion of the film due to an alien substance, or the like, is not caused. This is because voltage applied to the light-emitting layer can be made large. Considering this matter, the thickness is appropriately selected in accordance with structure of the film or the preparation process thereof.

The light-emitting layer and the dielectric layer are preferably provided by coating according to, for example, a spin coating method, a dip coating method, a bar coating method, and a spray coating method. Particularly, it is preferable to use a method having a great variety of subjects to be printed such as a screen-printing method or a method of enabling continuous coating such as a slide coating method. For example, the screen-printing method is to coat, through a screen mesh, a dispersion of phosphor or dielectric fine-particles dispersed in a high permittivity polymer solution. A film thickness can be controlled properly regulating thickness and/or numerical aperture of the screen mesh, and also selecting number of times in coating. Changing the dispersion to another one makes it possible to form not only a light-emitting layer and a dielectric layer, but also a backing electrode layer, and the like. In addition, to make into a large area can be easily attained by altering a screen size.

A film thickness of the dielectric layer for use in the present invention is preferably in the range of from 0.5 μm to 30 μm, more preferably in the range of from 0.5 μm to 15 μm, and most preferably in the range of from 1.0 μm to 15 μm. If the film thickness is too thin, it becomes difficult to form a uniform film by coating. As a result, it becomes difficult to form a material capable of giving uniform emission over a large area. On the other hand, if the film thickness is too thick, not only the material becomes thick, but also the voltage applied to a phosphor layer (light-emitting layer) decreases. As a result, in order to obtain a high luminance, high voltage to be applied and much energy consumption are needed. A variation of the film thickness of the dielectric layer is preferably ±10% or less, more preferably ±5% or less. If the variation is too large, problems such as electrical short circuit of a resulting device and emission unevenness owing to field concentration (centralization) arise.

Further, a film can be produced by a method of coating a dispersion or sol of dielectric fine-particles, and thereafter sintering the coating by such means of an electric furnace, an infrared lamp or a microwave. When ferroelectric fine-particles are used, a size of the ferroelectric particles to be used is preferably in the range of from 10 nm to 500 nm.

In order to provide a thin light-emitting layer adjacently on the dielectric layer, it is necessary that the light-emitting layer side surface of the dielectric layer has sufficient smoothness. For this purpose, in the case of the film made of dielectric particles, it is preferable to make this film surface smooth, for example, by providing a second dielectric layer having good smoothness, as described in U.S. Pat. No. 5,432,015, or by filling gaps among BaTiO₃ particles with BaTiO₃ sol, as described in Mat. Res. Bull., Vol. 36, p. 1065.

A typical electroluminescent device of the present invention is provided with a light-emitting layer containing the aforementioned luminescent particles (phosphor particles), a dielectric layer, and a pair of electrodes sandwiching the light-emitting layer and the dielectric layer between the electrodes.

If necessary, an additional layer may be provided on the device of the present invention.

For example, to prevent dielectric breakdown owing to pinhole or the like, or to prevent undesirable transferring of the constituting elements between the dielectric layer and the light-emitting layer, a thin film such as a silicon oxide film or an aluminum oxide film can be preferably provided adjacent to the light-emitting layer. Further, to inject electrons effectively into the light-emitting layer, an injection layer such as a yttrium oxide thin film or a hafnium oxide thin film may be preferably provided adjacent to the light-emitting layer.

The electrically conductive substrate that can be used in the present invention may be a substrate having electrical conductivity by itself, or a non-electrically conductive substrate having thereon an electrically conductive electrode layer. As the substrate, there is no particular restriction, so long as it has a requisite physical strength, resistance to heat, and flatness. Generally, metal, glass or ceramic materials are used. Preferable examples of the substrate include those made of alumina or zirconia.

In ordinary embodiments of the present invention, the device at least comprises a dielectric layer, a light-emitting layer, and a pair of electrodes which sandwiches these layers, and at least one of the electrodes is a transparent electrode. As the transparent electrode used for this purpose, generally used transparent electrode materials are arbitrarily used. Examples of the transparent electrode material include oxides such as tin-doped tin oxide, antimony-doped tin oxide, and zinc-doped tin oxide; multi-layer structure films of silver thin film sandwiched between high-refractive-index layers; and π-conjugated polymers, such as polyanilines and polypyrroles.

It is also preferable to arrange a tandem-type, grid-type, or the like type metal fine line on the transparent electrode, thereby to improve current-carrying performance.

The back electrode, which is present on the side from which light is not taken out, may be made of any material that has electric conductivity. The material is appropriately selected from metals such as gold, silver, platinum, copper, iron and aluminum; graphite, and other materials, considering the form of the device to be produced, the temperature in producing steps, and other factors.

The device of the present invention may have a device structure wherein a transparent electrode layer, a light-emitting layer, a dielectric layer, and a back electrode are successively arranged on a transparent substrate, thereby taking out light from the side of the substrate; or a device structure wherein an electrode layer, a dielectric layer, a light-emitting layer and a transparent electrode layer are successively arranged on a light non-transmissible substrate, thereby taking out light from the side opposite to the substrate. A structure wherein dielectric layers are arranged on both sides of a light-emitting layer may be employed for stable operation. In this case, however, it is necessary that the dielectric layer on the side from which light is taken out has sufficient light transmissibility. Further, if necessary, light can be taken out from an edge portion of the material. In this case, the two electrodes are made of a light reflective material.

The light-emitting device of the present invention is generally worked, at end of its production, with a suitable sealing material, so as to exclude effect of humidity from external environment. In the case that the substrate itself of the device has sufficient shielding property, a shielding sheet (to seal, for example, moisture or oxygen) may be put over the produced device and the surrounding of the device may be sealed with a hardening material such as epoxy resin.

The material for the above shielding sheet may be selected from glass, metal, plastic film, or the like, according to the application.

The materials and devices of the present invention are not particularly restricted in their application. However, taking the application as a light source into consideration, preferably the luminescent color is a white color.

As the method of outputting a white luminescent color, use can be preferably made, for example, of a method of using phosphor particles capable of self-emitting a white light such as zinc sulfide phosphor activated with copper and manganese and gradually cooled after baking, or a method of mixing two or more kinds of phosphors capable of emitting three primary colors or complementary colors from each other. For example, a combination of blue, green and red, and a combination of bluish green and orange may be used, to obtain a white light. It is also preferable to use a method of making into a white color according to the steps of emitting a short-wavelength light such as blue, and then using a fluorescent pigment or a fluorescent dye, thereby to wavelength-convert (emit) a part of the emission to green and red, as described in JP-A-7-166161, JP-A-9-245511 and JP-A-2002-62530. Further, as CIE chromaticity coordinates (x, y), it is preferable that the value x is in the range of 0.30 to 0.43 and the value y is in the range of 0.27 to 0.41.

Further, in the constitution of the device of the present invention, a substrate, a transparent electrode, a back electrode, any of various protective layers, a filter, a light-scattering reflecting layer, and the like may be provided, if necessary. As the substrate in particular, a flexible transparent resin sheet may also be used, in addition to a glass substrate or a ceramic substrate.

The electroluminescent material of the present invention, of the AC drive-type, enables making a device into a large area, as well as incomparable thinness. Further, the electroluminescent material of the present invention has not only a simple device structure and excellent flexibility but also lightweight and thinness.

The present invention will be explained in more detail by way of the following examples, but the invention is not intended to be limited thereto.

### EXAMPLES

### Example 1

(1) Preparation of a Slurry for a Dielectric Layer

To 1,000 mL of ethanol was added 37 g of titanium tetraisopropoxide. While the mixture solution was stirred, thereto was added 500 mL of a 4% ethanol solution of lactic acid. Further, thereto was added 500 mL of an aqueous acetic acid solution containing 51 g of barium acetate, and subsequently the resultant solution was allowed to stand at 60° C. for 5 hours under stirring. To the solution under stirring, was added 150 g of barium titanate fine-particle (primary particle diameter: 100 nm) that had been dispersed in advance in a mixture solution of water and methanol (1:1). While the solution was cooled, it was subjected to treatment with ultrasonic waves for 3 hours, to prepare a homogeneous slurry.

(2) Formation of a Dielectric Layer

On a 20-cm square, 200 μm-thick substrate, aluminum was vapor-deposited, to prepare a back electrode. The electrode was coated with the aforementioned slurry according to a screen-printing method, so that the deposited aluminum could be covered with the slurry. In that time, coating was carried out, of 5 μm thickness for each coating. After coating, the product was dried at 120° C., and then the coatings were repeated again and again in the same manner as mentioned above. Finally, a 20 μm-thick dielectric film was formed. The formed film had excellent surface smoothness, and a variation of film thickness of ±1.5 μm. Dielectric properties of the film were evaluated using a frequency property analytical instrument FRA 5095 (trade name, manufactured by NF Circuit Design Block Co.). As a result, it was confirmed that a dielectric constant of 120±10 was obtained within the range of from 100 Hz to 1 kHz.

(3) Formation of a Light-Emitting (Luminous Substance) Layer

To a closed-type reaction vessel heated to 70° C., an aqueous solution containing 6 moles of sodium sulfide, and an aqueous solution containing 6 moles of zinc nitrate, were added over 5 minutes, at an addition rate of 0.2 moles per minute. Further, each residue of these two aqueous solutions was added, over 1 hour. At that time, 0.6 moles of sodium sulfide, and one liter of a solution containing 0.6 moles of sodium chloride, were provided in advance in the reaction vessel, and the pH of the solution was adjusted to 2 or less, using sulfuric acid. Additionally, a copper sulfate solution was added, in a quantitative proportion of 0.1 mole % based on zinc. The above particle preparation resulted in zinc sulfide particles having an average particle diameter of 100 nm, a coefficient of deviation of 15%, and a zinc blende structure of about 90%. The resultant particles were baked at 600° C. for 1 hour under a nitrogen atmosphere, in such a manner that the particles would not sintered with each other by baking.

A proper quantity of the thus-obtained zinc sulfide particles, was mixed with a 30-mass % solution of a cyano resin dissolved in dimethylformamide, manufactured by Shinetsu Chemical Co., Ltd., to disperse the ZnS particles. Thus, a phosphor layer coating solution was prepared. Using the thus-prepared coating solution, the surface of the dielectric layer prepared in the aforementioned item (2) was coated, followed by drying, to prepare a 3.0 μm-thick light-emitting layer.

(4) Formation of an Upper Transparent Electrode

A transparent and electrically conductive ITO film, facing to the back electrode, was formed on the side of the substrate formed thereon the light-emitting layer, and the like, by a sputtering method. The film had a thickness of about 500 nm, and an area resistance of about 20 ohms.

The thus-prepared device was dried at 100° C. for several hours under a nitrogen atmosphere.

(5) Sealing

Each electric terminal for the external connection was taken out, using a silver paste, from the aluminum electrode and the transparent electrode of the aforementioned device. Thereafter, the device was sandwiched between two moisture-proof films, and the surroundings thereof was cured with an epoxy resin, to seal.

The operation in the above process was carried out under a nitrogen atmosphere.

(6) Measurement of luminescence Property

A sine-wave signal generator and a powder amplifier were used to apply an alternating-current electric field to the thus-prepared luminescent device, to measure luminescence intensity thereof with a luminance photometer BM9 (trade name) manufactured by Topcon Corp. As driving conditions, a frequency of 1 kHz and a voltage of 200 V were used.

Several kinds of devices were prepared in the same manner as in the aforementioned Example (Device A), except for changing the dielectric constant and the film thickness of the dielectric layer, by changing the primary particle diameter of BaTiO₃ in the dielectric layer, the drying temperature, and the number of times of coating. At this time, the deviation of thickness of the dielectric layer was measured.

In addition, several kinds of particles different in size and size distribution from each other were formed, changing the reaction temperature at the time of forming zinc sulfide particles.

Electroluminescent devices according to the present invention, and those for Comparative Examples, were prepared using the aforementioned particles, the layers, and the like, respectively. The thus-prepared electroluminescent devices were subjected to measurement of light-emitting luminance in the same manner as in the above.

The results are shown in Table 1.

The light-emitting luminance measured for each device is shown, in Table 1, as a relative value, i.e. relative luminance, in which the luminance in the Device A be represented by 100.

TABLE 1

| | | Variation | | Film | Deviation | | |
|---|---|---|---|---|---|---|---|
| | | coefficient | Thickness | thickness | of | Dielectric | |
| | Particle | of sphere | of light- | of | thickness | constant | |
| | size* of | equivalent | emitting | dielectric | of dielectric | of | |
| Device | phosphor | diameter | layer | layer | layer | dielectric | Relative |
| (Remarks) | (nm) | (%) | (μm) | (μm) | (%) | layer | luminance |
| A | 100 | 15 | 3.0 | 20 | ±7.5 | 120 | 100 |
| This invention | | | | | | | |
| B | 50 | 15 | 3.0 | 20 | ±7.5 | 120 | 150 |
| This invention | | | | | | | |
| C | 5 | 15 | 3.0 | 20 | ±7.5 | 120 | 150 |
| This invention | | | | | | | |
| D | 300 | 15 | 3.0 | 20 | ±7.5 | 120 | 30 |
| Comparative example | | | | | | | |
| E | 100 | 25 | 3.0 | 20 | ±7.5 | 120 | 100 |
| This invention | | | | | | | |
| F | 1000 | 15 | 3.0 | 20 | ±7.5 | 120 | 0 |
| Comparative example | | | | | | | |
| G | 100 | 15 | 3.0 | 20 | ±7.5 | 200 | 130 |
| This invention | | | | | | | |
| H | 100 | 15 | 3.0 | 20 | ±7.5 | 70 | 60 |
| Comparative example | | | | | | | |
| I | 100 | 15 | 10.0 | 20 | ±7.5 | 70 | 0 |
| Comparative example | | | | | | | |
| J | 100 | 15 | 1.0 | 20 | ±7.5 | 110 | 150 |
| This invention | | | | | | | |
| K | 100 | 15 | 0.5 | 20 | ±7.5 | 110 | 120 |
| This invention | | | | | | | |
| L | 100 | 15 | 3.0 | 0.5 | ±30 | 110 | 110 |
| This invention | | | | | | | |
| M | 100 | 15 | 3.0 | 50 | ±5.0 | 110 | 120 |
| This invention | | | | | | | |

Note:
*An average sphere equivalent diameter

As is apparent from Table 1, it was confirmed that the devices in which the materials of the present invention were used are excellent in luminance property.

### Example 2

Devices were prepared in the same manner as in Example 1, except for changing the size of the device to 1 meter square. As a result, it was confirmed that the devices of the present invention are thin and lightweight, and have such an excellent flexibility that the devices can be bent, and in addition the devices of the present invention are able to uniformly emit a light.

Having described our invention as related to the present embodiments, it is our intention that the invention not be limited by any of the details of the description, unless otherwise specified, but rather be construed broadly within its spirit and scope as set out in the accompanying claims.

1. An electroluminescent material, comprising:
a light-emitting layer that contains a luminescent particle having an average equivalent sphere diameter of from 2 nm to 150 nm, and that has a thickness of from 0.3 μm to 5 μm; and
a dielectric layer of dielectric constant of 100 or more, adjacent to said light-emitting layer.

2. The electroluminescent material according to claim 1, wherein the luminescent particle in the light-emitting layer has a coefficient of variation of 20% or less, in terms of equivalent sphere diameter.

3. The electroluminescent material according to claim 1, wherein a thickness of the dielectric layer is in the range of from 0.5 μm to 30 μm, and variation of the thickness is ±10% or less.

4. An electroluminescent device, comprising:
a light-emitting layer;
an dielectric layer; and
a pair of electrodes sandwiching the light-emitting layer and the dielectric layer between the electrodes,
wherein said light-emitting layer contains a luminescent particle having an average equivalent sphere diameter of from 2 nm to 150 nm, and has a thickness of from 0.3 μm to 5 μm; and
wherein said dielectric layer has a dielectric constant of 100 or more, and is adjacent to said light-emitting layer.

5. The electroluminescent device according to claim 4, wherein the luminescent particle in the light-emitting layer has a coefficient of variation of 20% or less, in terms of equivalent sphere diameter.

6. The electroluminescent device according to claim 4, wherein a thickness of the dielectric layer is in the range of from 0.5 μm to 30 μm, and variation of the thickness is ±10% or less.
